(19) United States
(12) Patent Application Publication
(10) Pub. No.: US 2026/0336434 A1
(43) Pub. Date: Oct. 29, 2026

(54) DIRECT CURRENT FAST CHARGING STATION INCLUDING RIPPLE CURRENT HEATING

(71) Applicant: GM Global Technology Operations LLC, Detroit, MI (US)

(72) Inventors: Chandra S. Namuduri, Troy, MI (US); Neeraj S. Shidore, Novi, MI (US); Xiaoling Chen, Troy, MI (US)

(21) Appl. No.: 19/187,134

(22) Filed: Apr. 23, 2025

(51) Int. Cl. B60L 53/10; B60L 53/16; B60L 53/22; B60L 53/30; B60L 53/62; B60L 53/66; H01M 10/052; H01M 10/44; H01M 10/48; H01M 10/615; H01M 10/625; H01M 10/637

(52) U.S. Cl. CPC B60L 53/11; B60L 53/16; B60L 53/22; B60L 53/305; B60L 53/62; B60L 53/66; H01M 10/052; H01M 10/443; H01M 10/486; H01M 10/615; H01M 10/625; H01M 10/637; B60L 2210/10; B60L 2210/30; H01M 2220/20

(57) ABSTRACT

A direct current (DC) fast charging station includes a power source. A bidirectional power converter is connected to the power source. The bidirectional power converter includes an alternating current (AC) to DC (AC-DC) inverter connected to the power source and a DC-DC converter connecting the AC-DC inverter to a charger port. A charge controller is communicatively coupled to the charger port and is controllably coupled to the bidirectional power converter. The charge controller includes a memory storing instructions configured to cause the charge controller to impose an AC ripple current on an output of the DC-DC converter.

### INTRODUCTION

The subject disclosure relates to direct current (DC) fast charging stations for electric vehicles, and more particularly to a DC fast charging station including ripple current heating functionality.

Electric vehicles include one or more rechargeable energy stores (e.g. batteries) within a rechargeable energy storage system (RESS) of the vehicle. The energy stored in the RESS is used to power electric propulsion motors, vehicle electronics, and any other electrical vehicle systems. The energy stores can be recharged by being connected to an external power source, allowing the RESS to receive electrical power from the external power source.

In some examples, the charge time required to fully restore the energy stores can be lengthy when using conventional AC power sources. In contrast, DC power can be provided fast enough and at a high enough magnitude to provide for fast charging. As a result, existing fast charging stations and power sources are designed to provide DC power and existing electric vehicles are designed to receive DC power from the fast charging stations.

One downside to DC charging is the possibility for the electric vehicle battery to experience lithium plating events when charged too fast while the battery is below a minimum temperature threshold. Existing vehicles use control systems that prevent the battery from being charged at all while the battery is below the temperature threshold. Prescriptive controls such as this can render the vehicle unable to be charged in certain cold conditions.

Accordingly, it is desirable to provide a fast charging DC station able to charge a vehicle at low temperatures.

In one exemplary embodiment a direct current (DC) fast charging station includes a power source. A bidirectional power converter is connected to the power source. The bidirectional power converter includes an alternating current (AC) to DC (AC-DC) inverter connected to the power source and a DC-DC converter connecting the AC-DC inverter to a charger port. A charge controller is communicatively coupled to the charger port and is controllably coupled to the bidirectional power converter. The charge controller includes a memory storing instructions configured to cause the charge controller to impose an AC ripple current on an output of the DC-DC converter.

In addition to one or more of the features described herein the power source is an alternating current (AC) electrical grid.

In addition to one or more of the features described herein the charger port includes a communication connection configured to communicate with a vehicle controller of a connected vehicle, and wherein the charge controller is configured to respond to communications from vehicle controller by setting a modulation amplitude and frequency of a phase shift between the voltages applied by a primary active bridge and a secondary active bridge of the DC-DC converter and thereby controlling a magnitude and frequency of the AC ripple current.

In addition to one or more of the features described herein the switching frequency of the DC-DC stage is in a range of at least twenty to five hundred times an AC ripple current frequency requested by the vehicle controller.

In addition to one or more of the features described herein wherein the DC-DC converter includes an isolating phase transformer.

In addition to one or more of the features described herein a magnitude of the AC ripple current is controlled by a magnitude of a phase shift between an applied voltages across an equivalent leakage inductance between the primary and secondary windings of the isolating phase transformer.

In addition to one or more of the features described herein the AC ripple current is controlled using a feed forward and output current feedback control.

In another exemplary embodiment, a vehicle includes a rechargeable energy storage system connected to a vehicle charging port. A vehicle controller is connected to the rechargeable energy storage system and the vehicle charging port. The vehicle controller includes a memory storing instructions configured to cause the controller to perform operations of: Initiating communications with a DC fast charging station connected to the vehicle charging port; determining that the DC fast charging station is equipped with alternating current (AC) ripple current capabilities. Determining a current state of the rechargeable energy storage system. Responding to the current state being receptive of AC ripple current heating by calculating a maximum AC ripple current amplitude based on a set of DC charge parameters of the rechargeable energy storage system. Determining an AC ripple current frequency based at least in part on a current temperature of the rechargeable energy storage system. Determining a DC charge current magnitude based on a current state of charge and temperature of the rechargeable energy storage system communicating the AC ripple current frequency and the maximum AC ripple current amplitude to the DC fast charging station.

In addition to one or more of the features described herein the set of DC charge parameters includes a zero crossing voltage, a DC current, a maximum charge voltage, and a minimum charge voltage parameter.

In addition to one or more of the features described herein determining the AC ripple current frequency based at least in part on the current temperature of the rechargeable energy storage system comprises comparing the current temperature and the state of charge of the rechargeable energy storage system to a lookup table.

In addition to one or more of the features described herein, the operations further include monitoring a temperature of the rechargeable energy storage system as a charge operation proceeds, and periodically recalculating the maximum AC ripple current, minimum AC ripple frequency, and the DC charging current.

In addition to one or more of the features described herein the operations further include requesting zero AC ripple current from the DC fast charging station responsive to the temperature of the rechargeable energy storage system exceeding a threshold temperature.

In addition to one or more of the features described herein the threshold temperature is a maximum temperature at which lithium plating occurs.

In addition to one or more of the features described herein the rechargeable energy storage system includes at least one Lithium cell.

In yet another exemplary embodiment, a method for heating a vehicle battery includes receiving a direct current (DC) fast charging current from a DC fast charger. The DC fast charging current includes an alternating current (AC) ripple current.

In addition to one or more of the features described herein a magnitude of the AC ripple current is set based on a maximum DC voltage allowed by a rechargeable energy storage system.

In addition to one or more of the features described herein the magnitude of the AC ripple current is controlled via a magnitude of a phase shift between applied voltages across an equivalent leakage inductance between primary and secondary windings of an isolating phase transformer.

In addition to one or more of the features described herein, the method further includes determining a current state of a rechargeable energy storage system, responding to the state of the rechargeable energy storage system being receptive of AC ripple current heating by calculating a maximum AC ripple current amplitude based on a set of DC charge parameters of the rechargeable energy storage system, determining an AC ripple current frequency based at least in part on a current temperature of the rechargeable energy storage system, and determining a DC charge current magnitude based on a current state of charge and temperature of the rechargeable energy storage system.

In addition to one or more of the features described herein, the method further includes communicating the AC ripple current frequency and the maximum AC ripple current amplitude to the DC fast charging station using a vehicle controller.

In addition to one or more of the features described herein, the method further includes stopping the AC ripple current responsive to a temperature of a rechargeable energy storage system exceeding a threshold.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an electric vehicle connected to a direct current (DC) fast charging station;

FIG. 2 is a DC fast charging configuration including alternating current (AC) ripple heating generation;

FIG. 3 is a process for simultaneously charging and heating an energy storage system on the vehicle of FIG. 1 using a DC fast charger with AC ripple current heating capabilities; and

FIG. 4 is a process for generating a ripple current lookup table according to one example.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term controller refers to a system including at least a processor and a memory, with the system being configured to perform or cause to be performed at least one operation. The system can be a dedicated controller including a single purpose processor and memory, a general control including one or more modules for performing the operation, a distributed system including multiple controllers in communication with each other and configured to control the operation, or any similar system.

In a general example, the apparatus and methods described herein provide a system for simultaneously or sequentially conditioning and charging a battery (or similar electric storage component) of an electric vehicle by providing a high voltage DC power including a high frequency AC ripple current to the battery. The AC ripple current is provided as a ripple current injection at a magnitude and frequency requested by the vehicle through a communication interface.

In some examples, the communication interface can be incorporated into a standardized charger configuration and operate using commands to request a desired mode of operations from the DC fast charging station, thereby allowing for DC fast charging process that is optimized for the vehicle being charged.

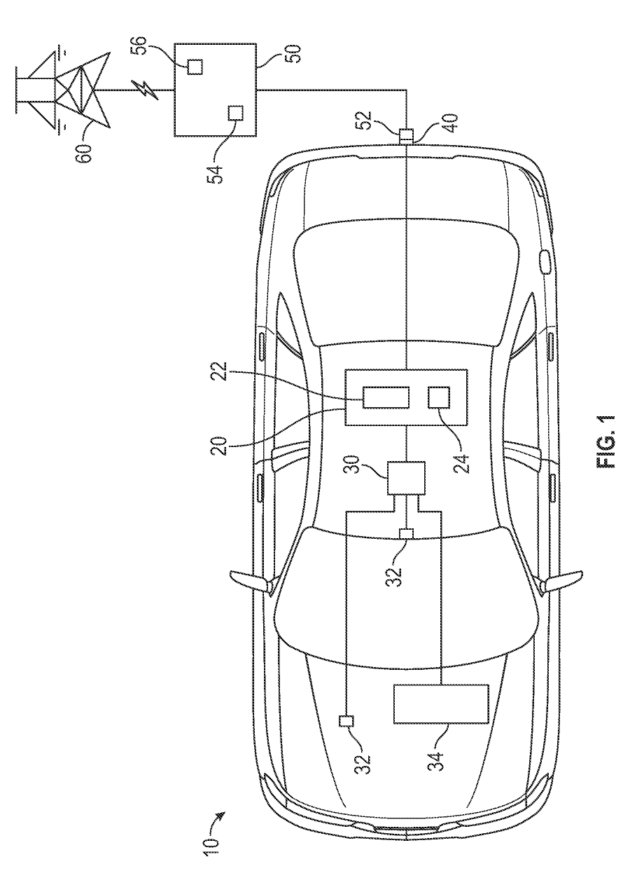

In accordance with an exemplary embodiment, FIG. 1 illustrates a vehicle 10 including a rechargeable energy storage system (RESS 20) and a controller 30. The RESS 20 includes an electric storage component (e.g. a battery 22) and a communication module 24. While charging, the RESS 20 is connected to a charging port 40. The controller 30 controls power provision from the RESS 20 to one or more electrical systems 32 onboard the vehicle and to an electric propulsion motor 34.

While charging at a direct current (DC) fast charging station 50, a charger 52 connects the charging port 40 to the DC fast charging station 50. The DC fast charging station 50 is connected to a power grid 60, or other power source. Included within the DC fast charging station is a bidirectional power converter circuit 54. The bidirectional power converter circuit 54 is capable of bidirectional power flow through a DC-DC stage and provides high bandwidth current control. The DC fast charging station includes a controller 56 configured to receive communications from and provide communications to a connected vehicle 10. In addition, the controller 56 is configured to control operations of the bidirectional DC-DC converter 54 according to any conventional converter control methodology.

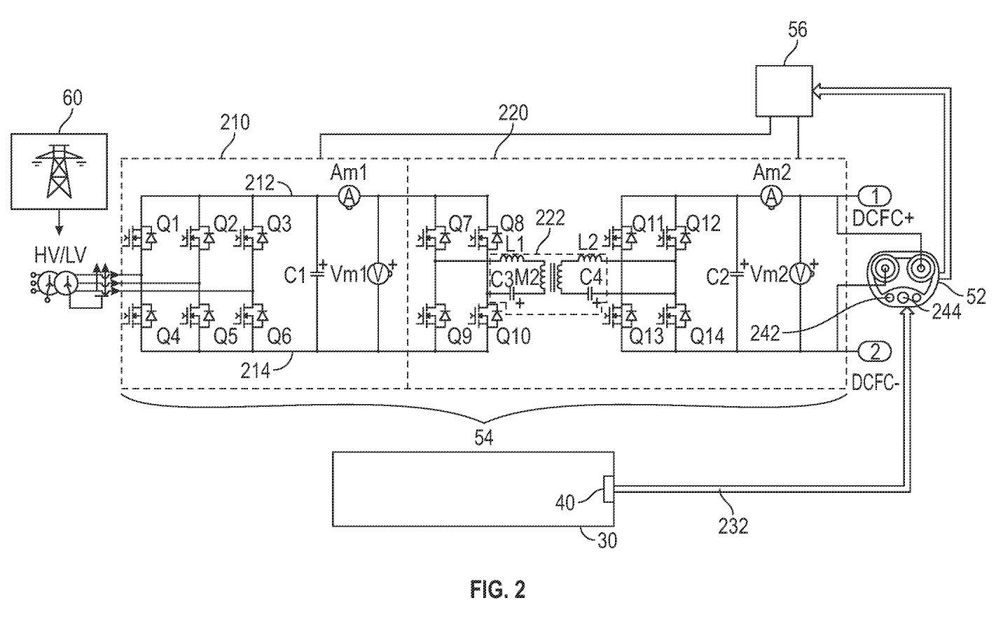

With continued reference to FIG. 1, FIG. 2 schematically illustrates the bidirectional power converter 54 as well as the connections to the power grid 60, the charger 52 and a vehicle controller 30.

The bidirectional power converter 54 includes a three phase power factor correction AC-DC stage (AC-DC stage 210) that uses an actively switched rectifier (switches Q1, Q2, Q3, Q4, Q5, Q6) to convert the received AC power into a DC power while controlling the switching of the switches Q1, Q2, Q3, Q4, Q5, Q6 to provide a power factor correction according to conventional switch controls. The DC power is provided across a positive bus 212 and a neutral/return bus 214 to a bidirectional power flow isolated DC-DC stage 220 (DC-DC stage 220). The DC-DC stage 220 is constructed of (switches Q7, Q8, Q9, Q10, Q11, Q12, Q13, Q14) in the form of a dual active bridge. The DC-DC stage 220 includes a primary bridge (Q7, Q8, Q9, Q10) and a secondary bridge (Q11, Q12, Q13, Q14) coupled by an isolating phase transformer 222. The isolating phase transformer includes a primary winding and a secondary winding with a predetermined leakage inductance. The leakage inductance is defined by the physical characteristics of the primary winding and the secondary winding.

During operation, the primary bridge Q7, Q8, Q9, Q10 is switched by the controller 56 to provide a first wave input (e.g. a square wave) to the isolating phase transformer 222. The secondary bridge Q11, Q12, Q13, Q14 is operated at a second switching to provide a second wave output of the isolating phase transformer 222. The second wave output is of the same type of wave (e.g. when the first wave input is a square wave, the second wave output is also a square wave).

By operating the first wave input and the second wave output out of phase with each other, an AC ripple current can be overlaid on top of the DC power output from the secondary bridge Q11, Q12, Q13, Q14, with a modulation amplitude and frequency of the phase shift between the voltages applied by the primary bridge and the secondary bridge controlling a magnitude and frequency of the AC ripple current.

In operation, a vehicle controller 30 provides a communication 232 to the charge port 40. The communication 232 is passed through one or more communication ports 242, 244 of the charger 52 to the controller 56 of the DC-DC fast charging station 50. The communication 232 defines the magnitude and frequency of the AC ripple current required by the vehicle 10. The controller 56 uses conventional control operations to convert the defined frequency and magnitude to corresponding switch operations. As the frequency of the AC ripple current is controlled by the switching of the DC-DC converter stage 220, the switches Q7, Q8, Q9, Q10, Q1, Q12, Q13, Q14 have a substantially higher bandwidth (rate at which the switches can be toggled) than the expected maximum AC ripple current frequency. In one example, the switches Q7, Q8, Q9, Q10, Q1, Q12, Q13, Q14 each have between 20 and 50 times the bandwidth of the maximum expected AC ripple current.

In some examples, the AC ripple current can be further controlled using a feed forward and output current feedback with resonant controls employed in the controller 56.

With continued reference to FIGS. 1 and 2, FIG. 3 illustrates a method 300 for providing DC fast charging including an AC ripple current. The process includes a combination of checks and steps performed by either, both, or a combination of a controller 30 on the vehicle 10 and the controller 56 in the DC fast charging station 50.

Initially, charger controller 56 checks to determine if the charger 52 is connected to a charge port 40 of a vehicle 10 at a charger connected check 310. If the charger is not connected, the controller does not start the charging in a no charging step 312.

If the charger 52 is connected to a charge port 40, the vehicle 10 and the DC fast charging station 50 communicate and the vehicle 10 determines whether the DC fast charging station 50 includes AC ripple current generation functions in an is ripple current available check 314.

If the connected DC fast charging station 50 does not include AC ripple current functions, the check 314 returns no, and the DC fast charging station 50 charges the vehicle 10 using conventional DC fast charging processes at a conventional DC fast charging step 316. As the conventional fast charge continues, the controllers 30, 56 monitor the state of charge of the battery 22 and check if the battery charging is complete in an is charge complete check 318.

When the charge is not complete, the process 300 returns to the check 314, and continues iterating. When the charge is complete (e.g. a desired state of charge has been reached) the process 300 ends in an end step 320.

When the charging station 50 is capable of providing AC ripple current (as with the charging station of FIGS. 1 and 2), the process 300 determines if a current state of the battery 22 is conducive to receiving a charge current with a superimposed AC ripple current at a check 322. In a typical example, the check 322 verifies that the temperature of the battery 22 is below a threshold temperature. In some examples, the threshold is set at a minimum temperature below which the battery may be subject to degradation due to DC fast charging. In other examples, the threshold is set at a maximum temperature above which heat generated by the AC ripple current may cause degradation of the battery 22.

When the state of the battery 22 is not conducive to receiving an AC ripple current, the process 300 proceeds to the conventional fast charging step 316.

When the state of the battery 22 is conducive to receiving an AC ripple current, the process 300 calculates a maximum current ripple current amplitude based on a zero crossing voltage, a DC current, and a maximum and minimum voltage acceptable by the battery 22 in a calculate maximum ripple current step 324. In some examples, the maximum ripple current is calculated such that the peak of the AC ripple current added to the positive DC voltage does not exceed the maximum DC voltage acceptable by the battery 22. The maximum ripple current is then able to be used as the amplitude to generate the AC ripple current.

After determining the maximum amplitude of the AC ripple current, the process 300 recieves a current state of charge and a current battery temperature and decides a minimum frequency of the batter 22 based on an apriori lookup table of state of charge, temperature, type of battery and cell form within the battery in a consult lookup table step 326. The current state of charge and temperature of the battery 22 may be determined via any conventional sensing method onboard the vehicle 10. The minimum frequency is a minimum frequency of AC switching at which the batter 22 will generate heat.

Once the amplitude and frequency of the AC ripple current are determined at steps 324 and 322 respectively, the magnitude of the DC charging current command is determined according to any conventional DC charge current determination at a DC current determination step 328.

In one example, steps 324, 326 and 328 are determined onboard the vehicle 10, and the resultant data is communicated to the DC fast charging station 50.

In another example, the base data used to make the determination of steps 324, 326, and 328 is provided to the dc fast charging station 50, and the controller 56 onboard the DC fast charging station makes the determination based on the provided data.

Once each step has been determined, the process 300 provides the final charging values to the DC fast charging station 50, and a DC charge with an AC ripple current is begun at a charge step 330.

Once charging has begun, the process monitors a current temperature of the battery 22 to ensure that the temperature does not exceed the threshold temperature in a battery temperature check 332. When the battery temperature is below the threshold temperature, the process 300 returns to step 324 and the AC ripple currents are recalculated using the same process. This loop iterates until the battery temperature meets or exceeds the threshold temperature, after which the process 300 proceeds to the conventional DC fast charging step 316 and ceases providing an AC ripple current.

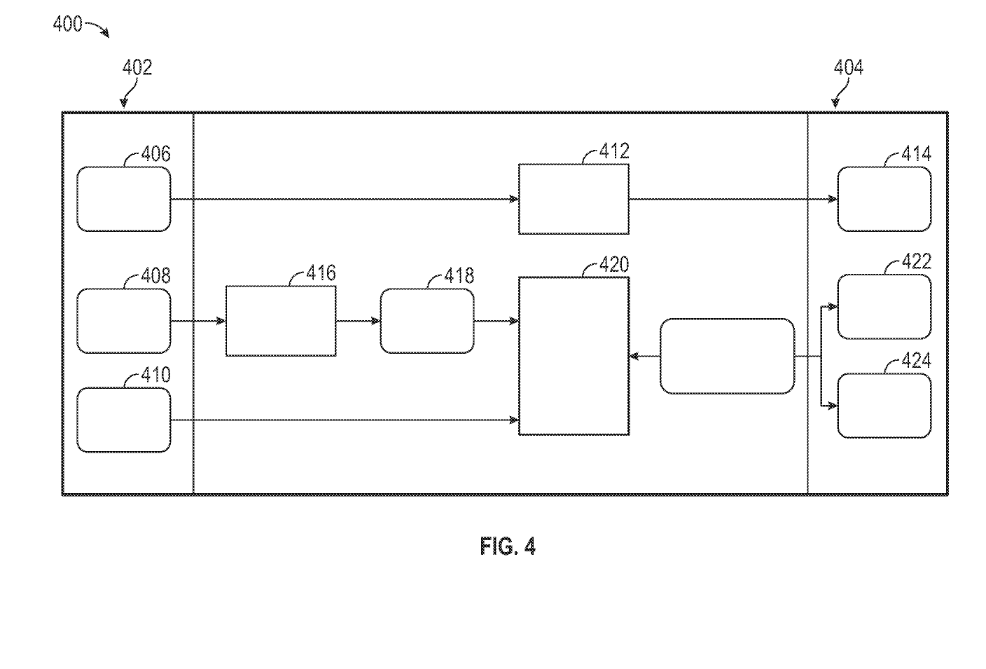

Referring again to the consult lookup table step 326, and with continued reference to all of FIGS. 1-3, FIG. 4 illustrates an exemplary process for generating the lookup table according to one example. In the example of FIG. 4 the impedance is generated via practical laboratory testing applied to all batteries 22 of the same configuration. In alternative examples, the table may be generated using simulations and practical testing and/or simulations alone. In yet further alternative systems, such as those where processing power is not a limiting factor, the lookup table may be omitted and instead the process illustrated in FIG. 4 may be used directly to generate the minimum frequency of the AC ripple current.

The process 400 recieves inputs 402 of a battery impedance 406, a current battery voltage 408, and a current battery temperature 410. Within the process 400, the received battery cell impedance 406 is applied to an electrochemical impedance spectography mapping step 412 to determine an AC ripple current frequency corresponding to the current battery state. The determined frequency is output to the lookup table as frequency value 414.

Simultaneously the current battery voltage 408 is applied to a zero crossing state of charge mapping process to determine a current state of charge 418 based on the voltage. The current state of charge 418 and the temerpature 410 of the battery 22 are applied to a calibration table 420 to determine a root mean square (RMS) current 422 for the AC ripple current and a DC current 424.

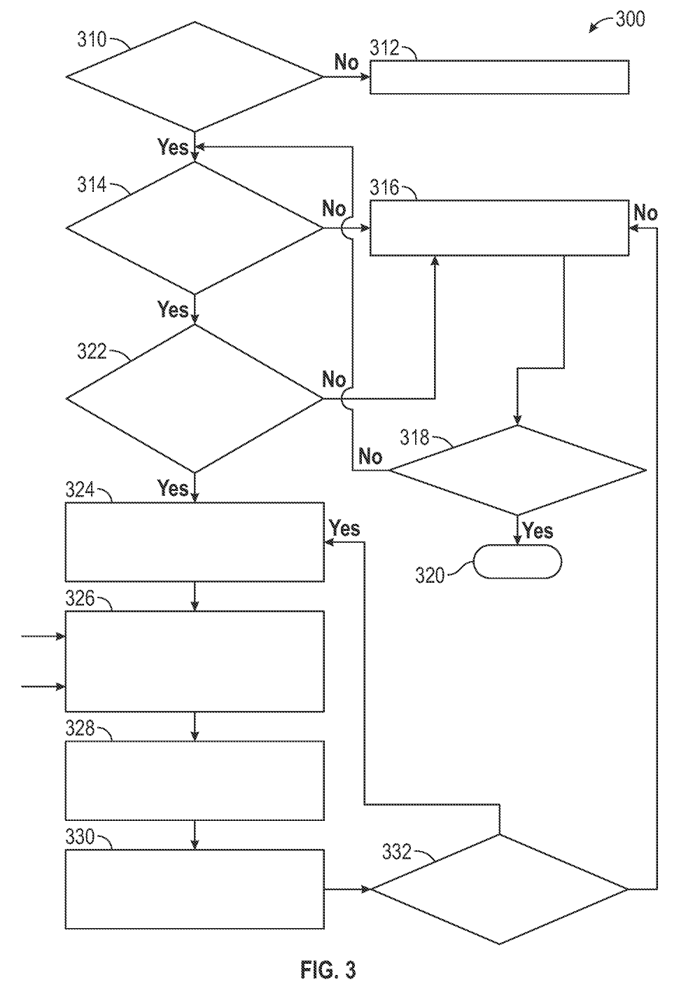

The AC frequency, RMS current 422 and DC current 424 are then associated with the input characteristics of inputs 406, 408, 410 to form the lookup table stored in the vehicle 10 and/or the DC fast charging station 50 and used in the process 300 of FIG. 3.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A direct current (DC) fast charging station comprising:
a power source;
a bidirectional power converter connected to the power source, the bidirectional power converter including an alternating current (AC) to DC (AC-DC) inverter connected to the power source and a DC-DC converter connecting the AC-DC inverter to a charger port; and
a charge controller communicatively coupled to the charger port and controllably coupled to the bidirectional power converter, the charge controller including a memory storing instructions configured to cause the charge controller to impose an AC ripple current on an output of the DC-DC converter.

2. The DC fast charging station of claim 1, wherein the power source is an alternating current (AC) electrical grid.

3. The DC fast charging station of claim 1, wherein the charger port includes a communication connection configured to communicate with a vehicle controller of a connected vehicle, and wherein the charge controller is configured to respond to communications from vehicle controller by setting a modulation amplitude and frequency of a phase shift between voltages applied by a primary active bridge and a secondary active bridge of the DC-DC converter and thereby controlling a magnitude and frequency of the AC ripple current.

4. The DC fast charging station of claim 3, wherein the switching frequency of the DC-DC stage is in a range of at least twenty to five hundred times an AC ripple current frequency requested by the vehicle controller.

5. The DC fast charging station of claim 1, wherein the DC-DC converter includes an isolating phase transformer.

6. The DC fast charging station of claim 5, wherein a magnitude of the AC ripple current is controlled by a magnitude of a phase shift between an applied voltages across an equivalent leakage inductance between primary and secondary windings of the isolating phase transformer.

7. The DC fast charging station of claim 1, wherein the AC ripple current is controlled using a feed forward and output current feedback control.

8. A vehicle comprising:
a rechargeable energy storage system connected to a vehicle charging port;
a vehicle controller connected to the rechargeable energy storage system and the vehicle charging port, wherein the vehicle controller includes a memory storing instructions configured to cause the vehicle controller to perform operations of:
initiating communications with a DC fast charging station connected to the vehicle charging port;
determining that the DC fast charging station is equipped with alternating current (AC) ripple current capabilities;
determining a current state of the rechargeable energy storage system;
responding to the current state being receptive of AC ripple current heating by calculating a maximum AC ripple current amplitude based on a set of DC charge parameters of the rechargeable energy storage system;
determining an AC ripple current frequency based at least in part on a current temperature of the rechargeable energy storage system;
determining a DC charge current magnitude based on a current state of charge and temperature of the rechargeable energy storage system;and
communicating the AC ripple current frequency and the maximum AC ripple current amplitude to the DC fast charging station.

9. The vehicle of claim 8, wherein the set of DC charge parameters includes a zero crossing voltage, a DC current, a maximum charge voltage, and a minimum charge voltage parameter.

10. The vehicle of claim 8, wherein determining the AC ripple current frequency based at least in part on the current temperature of the rechargeable energy storage system comprises comparing the current temperature and a state of charge of the rechargeable energy storage system to a lookup table.

11. The vehicle of claim 8, further comprising monitoring a temperature of the rechargeable energy storage system as a charge operation proceeds, and periodically recalculating the maximum AC ripple current, minimum AC ripple frequency, and the DC charging current.

12. The vehicle of claim 11, further comprising requesting zero AC ripple current from the DC fast charging station responsive to the temperature of the rechargeable energy storage system exceeding a threshold temperature.

13. The vehicle of claim 12, wherein the threshold temperature is a maximum temperature at which lithium plating occurs.

14. The vehicle of claim 8, wherein the rechargeable energy storage system includes at least one Lithium cell.

15. A method for heating a vehicle battery comprising:
receiving a direct current (DC) fast charging current from a DC fast charger, wherein the DC fast charging current includes an alternating current (AC) ripple current.

16. The method of claim 15, wherein a magnitude of the AC ripple current is set based on a maximum DC voltage allowed by a rechargeable energy storage system.

17. The method of claim 16, wherein the magnitude of the AC ripple current is controlled via a magnitude of a phase shift between applied voltages across an equivalent leakage inductance between primary and secondary windings of an isolating phase transformer.

18. The method of claim 15, further comprising:
determining a current state of a rechargeable energy storage system;
responding to a state of the rechargeable energy storage system being receptive of AC ripple current heating by calculating a maximum AC ripple current amplitude based on a set of DC charge parameters of the rechargeable energy storage system;
determining an AC ripple current frequency based at least in part on a current temperature of the rechargeable energy storage system; and
determining a DC charge current magnitude based on a current state of charge and temperature of the rechargeable energy storage system.

19. The method of claim 18, further comprising communicating the AC ripple current frequency and the maximum AC ripple current amplitude to the DC fast charging station using a vehicle controller.

20. The method of claim 15, further comprising stopping the AC ripple current responsive to a temperature of a rechargeable energy storage system exceeding a threshold.
